(19) United States
(12) Patent Application Publication
(10) Pub. No.: US 2018/0009280 A1
(43) Pub. Date: Jan. 11, 2018

(54) METHOD FOR MANUFACTURING A PRESSURE VESSEL AND A PRESSURE VESSEL OF THIS TYPE

(71) Applicant: PROGRESS-WERK Oberkirch AG, Oberkirch (DE)

(72) Inventors: Horst Siefermann, Achern-Wagshurst (DE); Nico Sucher, Achern (DE); Gerhard Mayer, Oberkirch (DE); Daniel Obert, Steinach (DE)

(21) Appl. No.: 15/641,540

(22) Filed: Jul. 5, 2017

(30) Foreign Application Priority Data
Jul. 5, 2016 (DE) 10 2016 112 307.2

(51) Int. Cl. B60G 11/30

(52) U.S. Cl. CPC B60G 11/30; B60Y 2304/05; B60G 2202/152; B60G 2206/82

(57) ABSTRACT

A method for manufacturing a pressure vessel for a motor vehicle comprises the steps: providing a hollow basic body as a primary stage of the pressure vessel, wherein the basic body has an initial internal volume, and wherein the basic body has a wall, which extends fully around a longitudinal axis of the basic body, wherein the wall has an opening, which has an opening rim; providing a hollow auxiliary body, which has a base wall and a peripheral wall, wherein the peripheral wall is open on a side lying opposite the base wall; joining the auxiliary body with the basic body at the opening in the wall of the basic body, such that the pressure vessel having a desired final internal volume which is larger or smaller than the initial internal volume of the basic body is obtained. In addition, such a pressure vessel in the form of an air suspension pot of a suspension is described.

### CROSS REFERENCE TO RELATED APPLICATION

This application claims priority from German patent application no. 10 2016 112 307.2 filed on Jul. 5, 2016. The entire content of this priority application is incorporated herein by reference.

### BACKGROUND OF THE INVENTION

The invention relates to a method for manufacturing a pressure vessel for a motor vehicle.

The invention further relates to a pressure vessel of this type.

A pressure vessel according to the present invention can be, in particular, an air suspension pot of an air suspension of a motor vehicle. An air suspension pot of a motor vehicle assumes, apart from the transmission of the generated forces from the suspension strut, also the function of a pressure vessel. Alongside further components, the air suspension pot provides the air volume necessary for the spring rate. In the following description, by a pressure vessel should be understood, in particular, an air suspension pot.

When a new motor vehicle model is developed, the necessary definitive internal volume of the pressure vessel can be defined only at an advanced project stage on the basis of vehicle road tests. At the start of the project, generally on the basis of specifications made by the manufacturer of the motor vehicle or its supplier of the superordinate system, here the suspension system, the pressure vessel is initially designed for a defined internal volume. Based on this definition, the manufacture of the necessary forming tools, the construction of jigs and fixtures, i.e. the necessary operating resources, and, where necessary, the system procurement for the manufacture of the pressure vessel, commences.

Since the target internal volume of the pressure vessel, which is determined within the road tests, frequently differs from the internal volume defined at the start, generally high alteration expenditures in respect of the operating resources, and possibly in respect of the production plant, are incurred, resulting in high costs. Furthermore, project end dates are thereby endangered or have to be deferred, whereby further costs can be incurred.

Conditional on the available installation space in the motor vehicle, for instance, an auxiliary air volume may also become necessary, which auxiliary air volume is provided in the form of an additional component, which is generally screwed separately to the suspension strut via a flange. As a result, costs are disadvantageously incurred through the manufacture and assembly of this component.

In many cases, no auxiliary volume in the form of a separate component, but an asymmetrical structure of the pressure vessel, is necessary in order to achieve the determined target internal volume of the pressure vessel. This dictates that the pressure vessel must often no longer be constructed in one part, but rather in multipart construction using individual parts which are difficult to produce. This entails risks in respect of the leak-tightness of the pressure vessel, as well as higher costs. Furthermore, the assembly processes are complicated by the multipart structure, which additionally impacts negatively on the cost situation.

Since, as previously described, the internal volume of the pressure vessel is generally variable only at high cost, the use of the same pressure vessel on a cross-vehicle basis is in many cases difficult.

### SUMMARY OF THE INVENTION

The object of the invention is therefore to define a method for manufacturing a pressure vessel for a motor vehicle, with which method it is possible to be able to manufacture a pressure vessel, in particular an air suspension pot, in a cost-effective manner, even when the target internal volume of the pressure vessel, determined on the basis of vehicle road tests, differs from the specifications at the start of a project.

Furthermore, the object of the invention is to provide a pressure vessel which can be manufactured in a cost-effective manner.

According to the invention, a method for manufacturing a pressure vessel for a motor vehicle is provided, comprising the steps:
providing a basic body as a primary stage of the pressure vessel, wherein the basic body has an initial internal volume, and wherein the basic body has a wall, which extends fully around a longitudinal axis of the basic body, wherein the wall has an opening, which has an opening rim;
providing a hollow auxiliary body, which has a base wall and a peripheral wall, wherein the peripheral wall is open on a side lying opposite the base wall;
joining the auxiliary body with the basic body at the opening in the wall of the basic body, such that the pressure vessel having a desired final internal volume which is larger or smaller than the initial internal volume of the basic body is obtained.

According to the method according to the invention, the pressure vessel is thus constructed from a basic body and an auxiliary body, wherein the auxiliary body is joined to the basic body. To this end, the wall of the basic body has an opening, in the region of which the auxiliary body is joined with the basic body. The auxiliary body can here provide an auxiliary volume, in that the interior of the hollow auxiliary body communicates with the interior of the basic body via the opening, or the auxiliary body can reduce the internal volume of the basic body, in that the auxiliary body reaches into the opening, without the cavity of the auxiliary body communicating with the interior of the basic body.

It will be evident that the wall of the basic body can also have a plurality of openings, as is provided in a preferred embodiment, and that a corresponding number of auxiliary bodies can be provided, which are than joined with the basic body at the openings.

The method according to the invention enables a maximal internal volume variance of the pressure vessel to be realized with minimal alteration cost, without an additional component or an asymmetrical multipart structure of the pressure vessel being necessary for this purpose. The internal volume variance can here be up to +−50% or more.

In particular, costly alterations to the basic body in the various development stages between the start of the project and the final design of the pressure vessel are not necessary, with the exception of the provision of the at least one opening in the wall of the basic body. The auxiliary volume or reduced volume is achieved by the auxiliary body, so that the pressure vessel can be produced with the desired final internal volume, i.e. the target internal volume.

The shape of the auxiliary body can be optional, though a shape of the kind which is capable of being deep-drawn is preferably chosen. A plurality of auxiliary bodies having different sizes and/or shapes, which provide different increased or reduced volumes, can also be provided.

One possible shape of the hollow auxiliary body is a prismatic, in particular cuboidal shape, in which one side of the cuboid is open. Other shapes than cuboidal shapes are equally possible, however.

With the method according to the invention, it is possible, moreover, to manufacture pressure vessels across all vehicle models at low alteration cost, since only the auxiliary body or elements have to be appropriately matched or differently positioned relative to the basic body, while the basic body can be used for a plurality of vehicle models, without alteration. By virtue of the invention, moreover, costly additional components or an asymmetrical multipart structure of the pressure vessel can be avoided.

The joining of the auxiliary body with the basic body has not only a connecting, but also a sealing function, so that the opening in the wall of the basic body, after the joining of the auxiliary body, is sealed off in a leak-tight, in particular gas-tight, in particular pressure-resistant manner.

In a preferred embodiment, the auxiliary body is provided such that a contour and dimensioning of the peripheral wall of the auxiliary body is at least approximately matched to a contour and dimensioning of the opening rim of the opening in the wall of the basic body.

This embodiment yields several advantages, which are manifested in part in the following further, preferred embodiments of the method.

Independently from the further, preferred embodiments to be described below, the aforementioned measure has the advantage that the auxiliary body scarcely influences the painting process. Since the finished pressure vessel, after its production, is painted also on the inside, for which purpose the paint is poured or sprayed into the cavity of the pressure vessel, the mutually matched contours and dimensionings of the peripheral wall of the auxiliary body and of the opening rim of the opening produce no recesses in which paint can collect, which paint is then prevented from flowing out of the pressure vessel.

In another preferred embodiment, which in particular is preferred in combination with the aforementioned embodiment, the auxiliary body, prior to the joining, is inserted partially into the opening with its open side to the fore, so that the desired final internal volume of the pressure vessel is obtained.

This embodiment of the method is particularly advantageous in terms of the cost expenditure. It is namely in this embodiment sufficient to provide, for each desired final internal volume of the pot-shaped pressure vessel, auxiliary bodies in one and the same shape and size. Different final internal volumes of the pressure vessel can be obtained by differently far insertion or plugging of the auxiliary body into the opening in the wall of the basic body. The further the auxiliary body is inserted into the opening, the smaller is the provided auxiliary volume. In this embodiment, a variability of the pressure vessel-internal volume is achieved with a minimum of parts.

In another preferred embodiment, the auxiliary body, prior to the joining, is inserted at least partially into the opening with the base wall to the fore, so that the desired final internal volume of the pressure vessel is obtained.

In this embodiment, the initial internal volume of the basic body can be reduced, so that the pressure vessel has a final internal volume which is smaller than the initial internal volume of the basic body. In this case, the advantage is once again that the reduction of the internal volume of the pressure vessel can be variably adjusted. A further advantage consists in the fact that even an auxiliary body of same shape and size can be used for the reduction of the internal volume of the pressure vessel as for the enlargement of the internal volume. The difference consists merely in the fact that the auxiliary body is in one case inserted into the basic body with the open side to the fore, and in the other case with the closed side to the fore. By virtue of this embodiment, a plurality of vehicle variants, which require different internal volumes of the pressure vessels, are served with the same basic vehicle kits and auxiliary bodies (so-called family concept).

All in all, a maximal internal volume variability of the pressure vessel is thus obtained with a minimum of parts.

In connection with the two aforementioned preferred embodiments, in another preferred embodiment it is provided that the joining of the auxiliary body comprises a joining of the peripheral wall of the auxiliary body with the opening rim of the opening in the wall.

In the case of that embodiment of the method in which the auxiliary body can be inserted with variable insertion depth into the opening in the basic body, this measure has the advantage that the joining of the auxiliary body can be realized from outside and is independent of the insertion depth of the auxiliary body. Thus, no conversions of the joining plant are necessary in order to manufacture pressure vessels having different internal volumes. In connection with one of the aforementioned embodiments, according to which the contour and dimensioning of the peripheral wall of the auxiliary body is at least approximately matched to the contour and dimensioning of the opening rim of the opening in the wall of the basic body, a high leak-tightness is achieved due to a positive-locking engagement of the peripheral wall of the auxiliary body with the opening rim of the opening in the wall of the basic body.

Alternatively to the embodiment of an insertable auxiliary body, in another preferred embodiment it is provided that the auxiliary body has on its open side a rim, the auxiliary body, prior to the joining, is fixed to the basic body with the rim around the opening in the wall of said basic body, and the rim of the open side of the auxiliary body is joined with the wall or the opening rim of the opening.

The advantage of this measure consists in the fact that the auxiliary body, in the joined state, is present only on the outer side of the basic body, and thus no part of the auxiliary body projects into the pressure vessel, as is the case with the plug-in variant of the auxiliary body. The aforementioned measure has the advantage that it impacts still less on the painting and also the joining process, or facilitates these two processes.

In order to obtain a high final internal volume variance of the pressure vessel within the aforementioned embodiment, the auxiliary body according to another preferred embodiment is provided having a predetermined internal volume of the auxiliary body, which internal volume is dimensioned such that, after the joining of the auxiliary body, the pressure vessel having the desired final internal volume is obtained, wherein the provision of the auxiliary body having the predetermined internal volume can comprise a shortening of the auxiliary body.

As the joining method, in the method according to the invention for joining the auxiliary body to the basic body, all common joining methods can be used, in particular welding, gluing, pressing and/or soldering.

In another preferred embodiment of the method, the auxiliary body is provided as a deep-drawn part.

The advantage of this embodiment consists in a further cost reduction in the manufacture of the pressure vessel. Equally, the basic body can also be produced as a one-piece deep-drawn part or can be composed of a plurality of deep-drawn parts.

As already mentioned above, the basic body can be provided having a plurality of openings distributed in the wall, wherein a plurality of auxiliary bodies are provided, which, in order to obtain the pressure vessel having the desired final internal volume, are joined with the basic body at the openings.

This measure is of advantage in particular when the available installation space for the pressure vessel in the vehicle is restricted around the pressure vessel, wherein, with the aforementioned embodiment, an auxiliary volume can be distributed amongst a plurality of auxiliary bodies, which then protrude less far from the basic body in the radial direction than if the same auxiliary volume must be provided only by a single auxiliary body. This embodiment thus has the advantage that it is particularly space-saving.

The method according to the invention for manufacturing a pressure vessel, which method is here described, can be used both if the basic body is in one piece, and in respect of multipart basic bodies. In the latter case, the opening in the wall of the basic body can be made in or introduced into the wall of the basic body such that it reaches over individual parts. For instance, a part of the opening can be configured on a first basic body part, and the remaining part of the opening on the other basic body part, so that the opening rim, as in the case of a one-piece basic body, extends preferably along a continuous line.

According to the invention, a pressure vessel for a motor vehicle, comprising a basic body, is also provided, wherein the basic body has an internal volume, and wherein the basic body has a wall, which extends fully around a longitudinal axis of the basic body, wherein the wall has an opening, which has an opening rim, and comprising a hollow auxiliary body, which has a base wall and a peripheral wall, wherein the auxiliary body is open on a side lying opposite the base wall, and wherein the auxiliary body is joined with the basic body at the opening in the wall of the basic body, whereby the pressure vessel has an internal volume which is larger or smaller than the internal volume of the basic body.

The advantages stated in connection with the representation of the method according to the invention apply also to the pressure vessel according to the invention and to the below-stated preferred embodiments of the pressure vessel.

Preferably, a contour and dimensioning of the peripheral wall of the auxiliary body is at least approximately matched to a contour and dimensioning of the opening rim of the opening in the wall of the basic body.

Further preferably, the auxiliary body is inserted partially into the opening in the wall of the basic body with the open side to the fore, in particular is plugged-in in positive-locking engagement.

Alternatively hereto, the auxiliary body is inserted at least partially into the opening with the base wall to the fore, in particular is plugged-in in positive-locking engagement.

Further preferably, the auxiliary body has on its open side a rim, and the auxiliary body is fixed to the basic body with the rim around the opening in the wall of said basic body, and the rim of the open side of the auxiliary body is joined with the wall or the opening rim of the opening.

Further preferably, the basic body has a plurality of openings distributed in the wall, wherein a plurality of auxiliary bodies are joined with the basic body at the openings in the wall.

Further preferably, the pressure vessel is a pot-shaped pressure vessel having a pot-shaped basic body. Further preferably, the pressure vessel is an air suspension pot of an air suspension for a motor vehicle.

Further advantages and features emerge from the following description and the appended drawings.

It will be evident that the aforementioned features, which are to be further explained below, are usable not only in the respectively defined combination, but also in other combinations or in isolation, without departing from the scope of the present invention.

### BRIEF DESCRIPTION OF THE DRAWINGS

Illustrative embodiments of the invention are represented in the drawing and are described in greater detail below with reference to said drawing, wherein:

FIG. 1 shows a basic body as a primary stage of a pressure vessel for a motor vehicle, in perspective representation;

FIG. 2 shows an auxiliary body for connection to the basic body in FIG. 1 for the manufacture of the pressure vessel;

FIG. 3 shows a pressure vessel produced from the basic body in FIG. 1 and auxiliary body in FIG. 2, according to a first embodiment;

FIG. 4 shows a pressure vessel produced from the basic body in FIG. 1 and the auxiliary body in FIG. 2, according to a further embodiment;

FIG. 5 shows a pressure vessel produced from the basic body in FIG. 1 and the auxiliary body in FIG. 2, according to a still further construction variant;

FIG. 6 shows one embodiment of a pressure vessel, which embodiment is modified in relation to the pressure vessel in FIG. 3;

FIG. 7 shows an embodiment which is modified in relation to the pressure vessel in FIG. 6; and

FIG. 8 shows a pressure vessel according to a still further embodiment.

### DESCRIPTION OF PREFERRED EXEMPLARY EMBODIMENTS

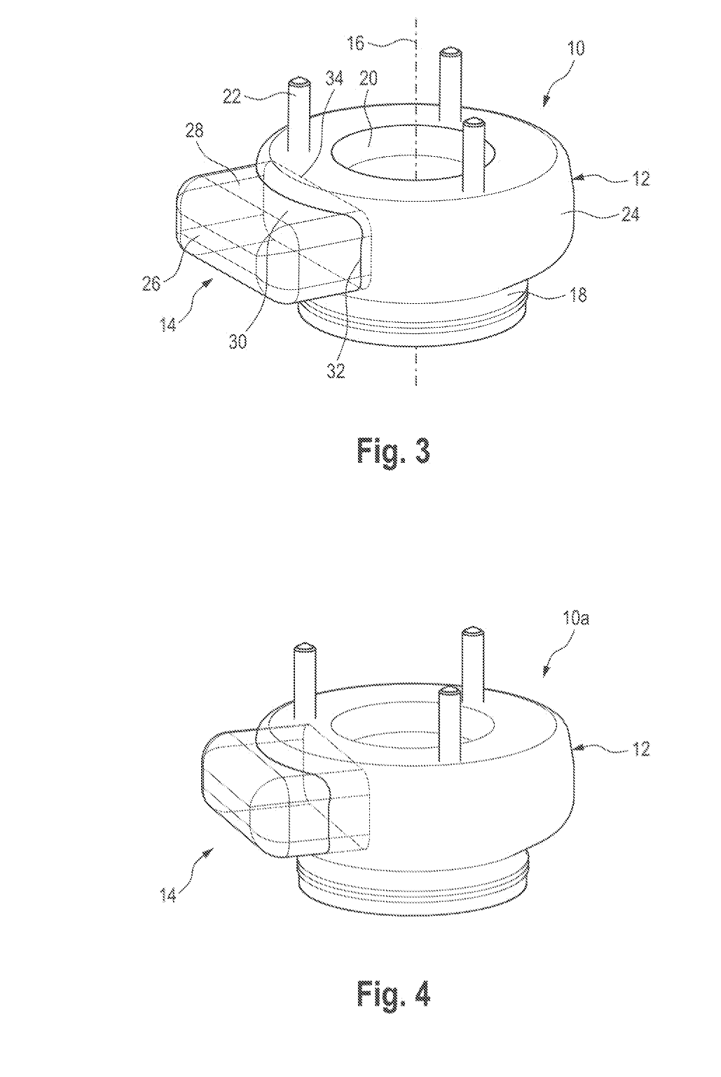

FIG. 3 shows a pot-shaped pressure vessel provided with the general reference symbol 10. The pressure vessel 10 is, in particular, an air suspension pot for an air suspension for a motor vehicle.

The pressure vessel 10 has a basic body 12, which is pot-shaped, and an auxiliary body 14, which is joined with the basic body 12, as will be further described.

In the illustrative embodiment of FIG. 3, the basic body 12 is a one-piece pot, in particular a pot manufactured at least in part by deep drawing. The basic body 12 has a longitudinal axis 16. In the present illustrative embodiment, the basic body 12 is rotationally symmetric with respect to the longitudinal axis 16, while in other illustrative embodiments the basic body 12 can also be non-rotationally symmetric with respect to the longitudinal axis 16.

The basic body 12 has a flange 18, which can serve for the attachment, for instance, of a bellows (not represented). On its side lying opposite the flange 18, the basic body 12 has an opening, which serves for the installation of further parts of the air suspension, such as, for instance, a shock absorber. The basic body 12, and thus the pressure vessel 10, can be secured via fastening means 22 (represented by way of example in FIG. 3) to a vehicle body, usually a dome.

The basic body 12 has a wall 24 extending fully around the longitudinal axis 16, which wall, as the wall extending fully around the longitudinal axis 16, is the side wall of the basic body 12, or which wall, in other words, extends in the direction of the longitudinal axis. In the fitted position of the pressure vessel in a vehicle, the wall 24 runs substantially vertically.

The auxiliary body 14 is, like the basic body 12, a hollow body, and has a base wall 26 and a peripheral wall 28.

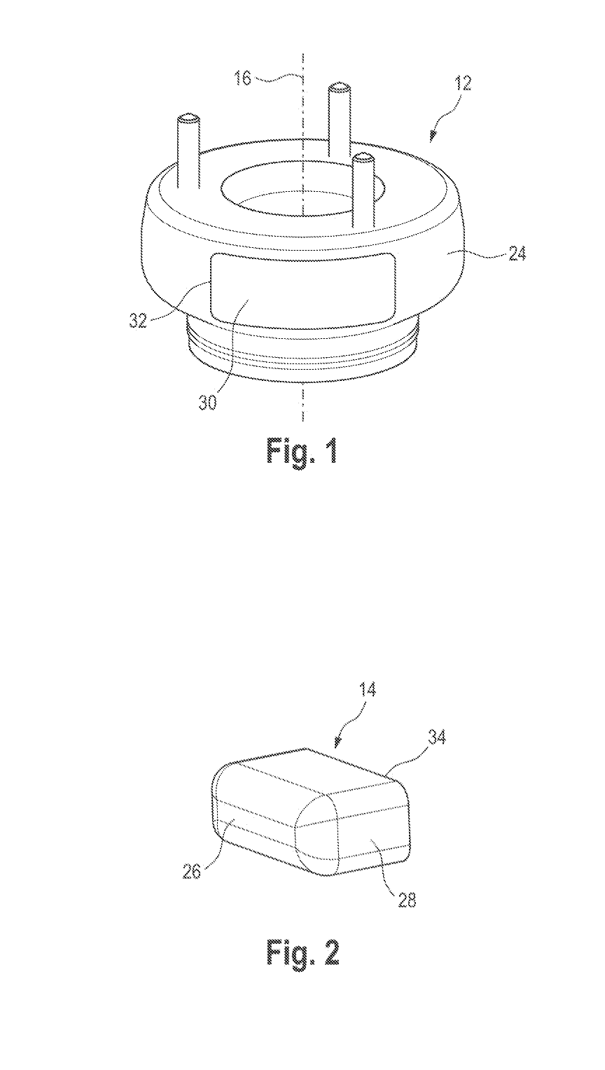

Further details of the basic body 12 and of the auxiliary body 14 are described below with reference to FIGS. 1 and 2, on the basis of which a method for manufacturing the pressure vessel 10 in FIG. 3 is also described.

FIG. 1 shows the basic body 12 in isolation. In a method for manufacturing the pressure vessel 10, the basic body 12 is provided as a primary stage of the pressure vessel 10. The basic body 12 is here provided having an opening 30, which has an opening rim 32, in the wall 24. The opening 30 can have been retrospectively made in the wall 24, while the basic body 12 was initially provided having a closed wall 24 not containing the opening 30.

The opening 30 is substantially rectangular with rounded corners, wherein the rectangular form of the opening 30 is only exemplary. For instance, the opening 30 can also be circular.

In the initial state shown in FIG. 1, the basic body 12 has an initial internal volume, which, at the start of a development project, was designed according to certain specifications. In the initial state, the basic body 12 can thus constitute the pressure vessel, which, within road tests, is used to determine the later definitive target internal volume of the pressure vessel 10. In these road tests, the opening 30 is not present, or at least is sealed. With the pressure vessel 10 according to the invention, road tests can also be conducted iteratively in order to determine step by step the definitive target internal volume of the pressure vessel 10, without the need to invest an increased manufacturing outlay in the pressure vessel, as will be evident from the following description.

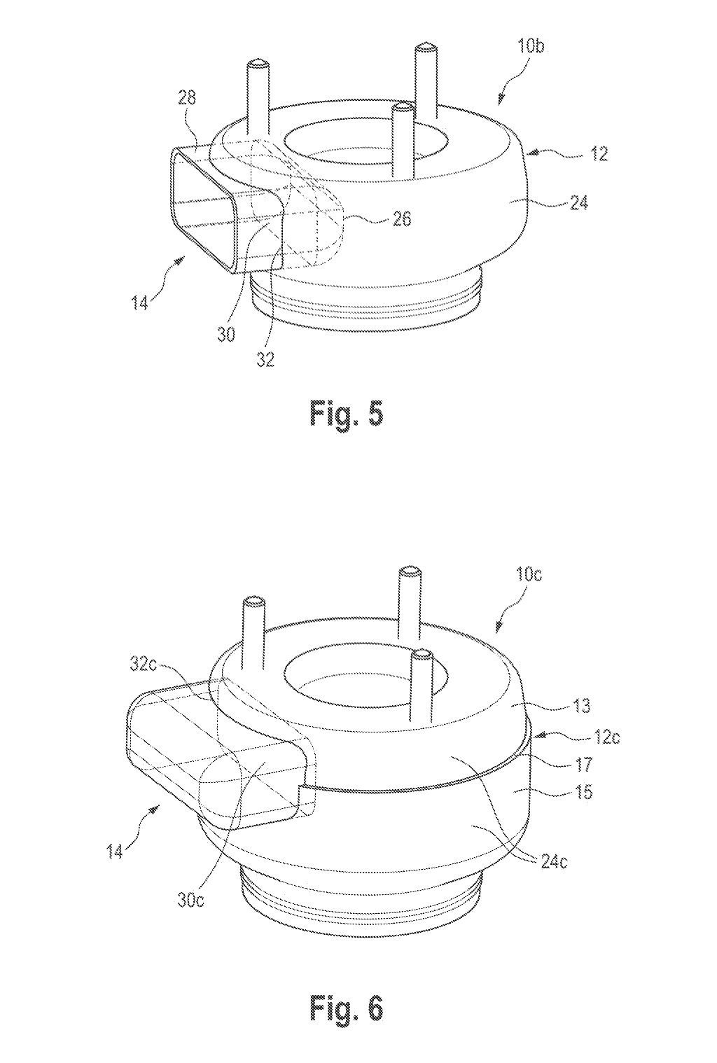

Within the manufacture of the pressure vessel 10 in FIG. 3, there is additionally provided the auxiliary body 14, which in FIG. 2 is shown in isolation. The auxiliary body 14 has the base wall 26 and the peripheral wall 28. The peripheral wall 28, and thus the auxiliary body 14, is open on the side 34 lying opposite the base wall 26, as can be seen in FIG. 5.

In the shown illustrative embodiment, the auxiliary body 14 has the shape of a unilaterally open cuboid, the dimensioning and contour of which is appropriately matched to the shape and dimensioning of the opening 30 in the basic body 12. In other illustrative embodiments, in which the opening is, for instance, circular, the auxiliary body correspondingly has a circular peripheral wall 28.

In order to manufacture the pressure vessel 10, the auxiliary body 14 is joined with the basic body 12 at the opening 30 in the wall 24 of the basic body 12, such that the pressure vessel 10 having the desired final internal volume or target internal volume, which is larger or smaller than the initial internal volume of the basic body 12 according to FIG. 1, is obtained.

FIG. 3 shows the case in which the pressure vessel 10 is intended to have a final internal volume or target internal volume which, on the basis of the conducted road tests, must be larger than the initial internal volume of the basic body 12. In order to achieve this final internal volume, the auxiliary volume provided by the auxiliary body 14 is now used. In this case, the auxiliary body 14 is joined with its open side 34 at the opening 30 in the wall 24 of the basic body 12.

In the illustrative embodiment shown in FIG. 3, the auxiliary body 14 is configured as an insertion part or plug-in part, wherein a contour and dimensioning of the peripheral wall 28 of the auxiliary body 14 is at least approximately matched to the contour and dimensioning of the opening rim 32 of the opening 30 in the wall 24 of the basic body 12, as has already been described above. In this way, the auxiliary body 14 can be inserted into the opening 30 in the basic body 12 with its open side 34 to the fore, to the point where the desired final internal volume of the pressure vessels 10 is achieved. As a result of the stepless insertability of the auxiliary body 14, the desired final internal volume of the pressure vessel 10 can be accurately adjusted. As soon as that insertion depth of the auxiliary body 14 which is necessary for the achievement of the desired final internal volume of the pressure vessel 10 is set, the auxiliary body is joined by joining of the peripheral wall 28 of the auxiliary body 14 with the opening rim 32 of the opening 30 in the wall 24 of the basic body 12. The joining line here runs along the opening rim 32 of the opening 30. Through the matching of contour and dimensioning of the peripheral wall 28 to the contour and dimensioning of the opening rim 32, the auxiliary body 14 sits in positive-locking engagement in the opening 30 in the basic body 12, so that, in the joining process, no great gaps have to be sealed, and the leak-tightness of the pressure vessel can be more easily ensured.

The joining is preferably realized by welding. Other joining methods such as gluing, pressing, soldering, can, however, likewise be used. Moreover, the joining establishes the final leak-tightness of the bond of auxiliary body 14 and basic body 12 at the opening 30.

FIG. 4 shows a pressure vessel 10a, which is formed of the same basic body 12 in FIG. 1 and the same auxiliary body 14 in FIG. 2 as the pressure vessel 10, and which merely has the difference to the pressure vessel 10 that the auxiliary body 14 is inserted further into the basic body 12 than is the case with the pressure vessel 10. As a result, the final internal volume of the pressure vessel 10a is larger than the initial internal volume of the basic body 12, but smaller than the final internal volume of the pressure vessel 10.

While, in the pressure vessel 10 and the pressure vessel 10a, the auxiliary body 14 is inserted into the opening 30 in the basic body 12 with the open side 34 to the fore in order to achieve a final internal volume of the pressure vessel 10 or 10a which is larger than the initial internal volume of the basic body 12, FIG. 5 shows a construction variant in which, again with the same basic body 12 in FIG. 1 and the same auxiliary body 14 in FIG. 2, a pressure vessel 10b, the final internal volume of which is smaller than the initial internal volume of the basic body 12, can be manufactured. To this end, in the method for manufacturing the pressure vessel 10b, the auxiliary body 14 is inserted into the opening 30 in the basic body 12 with its closed base wall 26 to the fore, so that the interior of the auxiliary body 14 does not communicate with the interior of the basic body 12. The initial internal volume of the basic body 12 is hereby reduced by the volume of the inserted portion of the auxiliary body 14.

Once the auxiliary body 14 is inserted, with the insertion depth necessary for the setting of the desired final internal volume of the pressure vessel 10b, in the opening 30 in the basic body 12, the auxiliary body 14 is joined with the basic body at the opening 30, in that the peripheral wall 28 of the auxiliary body 14 is joined with the opening rim 32 of the opening 30 in the wall 24 of the basic body 12.

In the illustrative embodiment in FIG. 5, that part of the auxiliary body 14 which protrudes outward from the wall 24 can be cut off, should this be necessary for reasons of installation space, or, for instance, an auxiliary body which has a lesser length in the insertion direction can be used from the outset.

The advantages of the method according to the invention for manufacturing a pressure vessel, and those of the pressure vessel, are manifested particularly clearly on the basis of FIGS. 3 to 5, since identical components, namely the basic body 12 and the auxiliary body 14, can be used in unchanged form to manufacture pressure vessels 10, 10a and 10b having different final internal volumes, and this with the same tools, operating resources and the same production plant, resulting in a significant reduction in costs.

Thus, with same components, various pressure vessels are also able to be manufactured across vehicle models at no additional cost (so-called family concept).

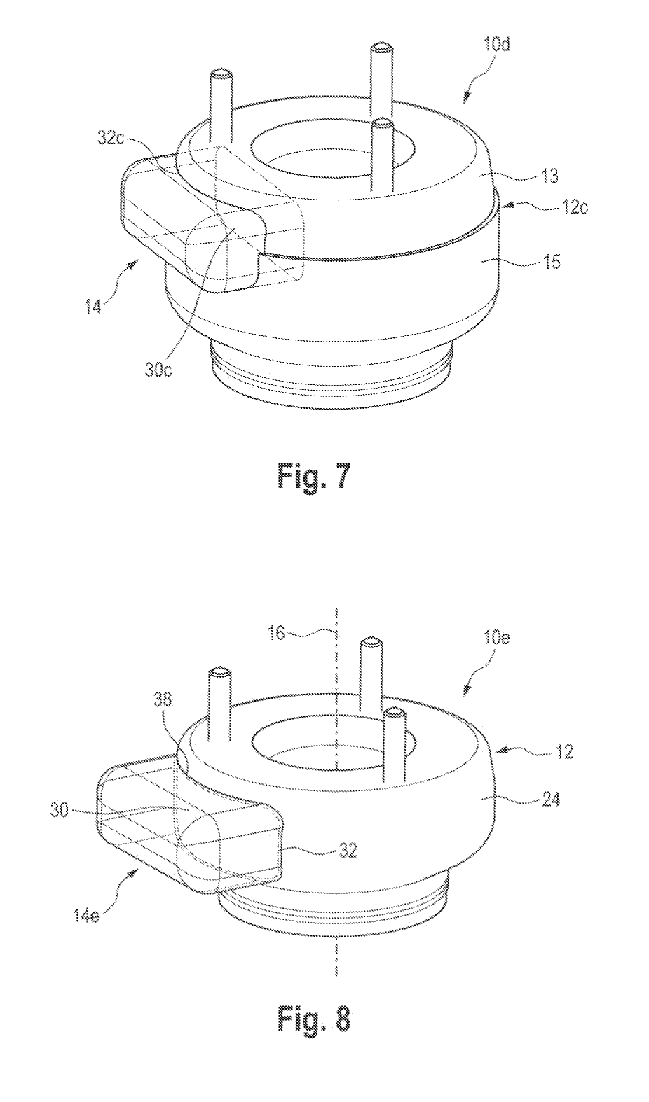

That principle of manufacture of a pressure vessel which has been described with reference to FIGS. 1 to 5 can also be applied when the basic body is of multipart construction, as shown in FIGS. 6 and 7. FIG. 6 shows a pressure vessel 10c, which is constructed from a basic body 12c formed of two basic body parts 13 and 15.

The two basic body parts 13 and 15 are joined together along a connecting seam 17, for instance by welding or other common joining methods. Both parts 13 and 15 together have a wall 24c, which has an opening 30c spread over both parts 13 and 15. Correspondingly, the opening rim 32c of the opening 30c extends over both parts 13 and 15 of the basic body 12b. Here too, the same auxiliary body 14 as in the pressure vessels 10 and 10a, which, as in FIGS. 3 and 4, is configured as a plug-in part, can again now be used.

FIG. 7 shows a pressure vessel 10d, which is constructed from the same basic body 12c as the pressure vessel 10c, with the difference that the auxiliary body 14 is inserted further into the opening 30c, as in the case of the pressure vessel 10a in FIG. 4.

Without this being represented in the drawing, it will be apparent to the person skilled in the art that also the embodiment in FIG. 5 can be used in respect of the basic body 12c if a pressure vessel, the final internal volume of which is smaller than the initial internal volume of the basic body 12c, is intended to be made from the basic body 12c.

FIG. 8 shows a further embodiment of a pressure vessel 10e which is manufactured according to a method that is modified in relation to the previous embodiments.

The pressure vessel 10e has the same basic body 12 in FIG. 1 as the pressure vessels 10 and 10a. Compared to the auxiliary bodies 14 of the previous Illustrative embodiments, the auxiliary body 14e is not configured as a plug-in or insertion part, but rather the auxiliary body 14e is fixed to the outer side of the wall 24 of the basic body 12 at the opening 30 and thus does not project into the inside of the basic body 12. To this end, the auxiliary body 14e has a rim 38, the contour of which is matched to the outer contour of the wall 24, and, in accordance with the shown illustrative embodiment of a basic body 12 having a, with respect to the longitudinal axis, circular wall 24, is configured, viewed from the longitudinal axis 16, concavely in the peripheral direction about the longitudinal axis 16. The rim 38 is also matched in terms of its contour and dimensioning to the opening rim 32 in the wall 24 of the basic body 12, so that the rim 38 of the auxiliary body 14e bears, substantially flush with the rim 32 of the opening 30, against the wall 24 of the basic body 12. The rim 38 which borders the open side of the auxiliary body 14e is joined with the wall 24 or the opening rim 32.

In order to achieve in this embodiment the desired final internal volume or target internal volume of the finished pressure vessel 10e, the auxiliary body 14e is provided having a predetermined length and width, or a predetermined internal volume which is dimensioned such that, after the joining of the auxiliary body 14e, the pressure vessel 10e having the desired final internal volume is obtained.

To this end, starting from the auxiliary body 14 in FIG. 1, this can be shortened, for instance, to a length which is necessary for the achievement of the desired final internal volume of the pressure vessel 10e.

The auxiliary body 14e can, of course, also be used with the basic bodies 12c in FIGS. 6 and 7.

The auxiliary bodies 14 and 14e are preferably produced as deep-drawn parts.

From the representations in FIGS. 3 to 8, it is additionally evident that the described manufacturing method does not impair the process of internal painting of the respective pressure vessel 10 to 10e, since excess paint can flow off from the inside of the respective pressure vessel and does not get trapped in recesses and dry on there.

While, in the shown and above-described illustrative embodiments, only one auxiliary body 14 or 14e is used for the manufacture of a pressure vessel, it is equally possible, however, within the scope of the invention, to distribute a plurality of such auxiliary bodies on the wall 24 or 24c, in which case a corresponding number of openings can be provided in the wall 24 or 24c. As a result, an auxiliary volume, in particular an added volume, can be distributed amongst a plurality of auxiliary bodies, without the finished pressure vessel being built large in the radial direction with respect to the longitudinal axis 16. A plurality of auxiliary bodies are also suitable, however, where a reduced volume of the pressure vessel must be obtained in relation to the initial internal volume of the basic body.

Moreover, it will be evident that the herein described method for manufacturing a pressure vessel is usable not only with rotationally symmetric basic bodies, but also with basic bodies which are not rotationally symmetric with respect to the longitudinal axis 16.

1. A method for manufacturing a pressure vessel for a motor vehicle, comprising the steps:
providing a hollow basic body as a primary stage of the pressure vessel, wherein the basic body has an initial internal volume, and wherein the basic body has a wall, which extends fully around a longitudinal axis of the basic body, wherein the wall has an opening, which has an opening rim;
providing a hollow auxiliary body, which has a base wall and a peripheral wall, wherein the peripheral wall is open on a side lying opposite the base wall;
joining the auxiliary body with the basic body at the opening in the wall of the basic body, such that the pressure vessel having a desired final internal volume which is larger or smaller than the initial internal volume of the basic body is obtained.

2. The method as claimed in claim 1, wherein the auxiliary body is provided such that a contour and dimensioning of the peripheral wall of the auxiliary body is at least approximately matched to a contour and dimensioning of the opening rim of the opening in the wall of the basic body.

3. The method as claimed in claim 1, wherein the auxiliary body, prior to the joining, is inserted partially into the opening with the open side to the fore, so that the desired final internal volume of the pressure vessel is obtained.

4. The method as claimed in claim 1, wherein the auxiliary body, prior to the joining, is inserted at least partially into the opening with the base wall to the fore, so that the desired final internal volume of the pressure vessel is obtained.

5. The method as claimed in claim 3, wherein the joining of the auxiliary body comprises a joining of the peripheral wall of the auxiliary body with the opening rim of the opening in the wall.

6. The method as claimed in claim 1, wherein the auxiliary body has on its open side a rim, the auxiliary body, prior to the joining, is fixed to the basic body with the rim around the opening in the wall of said basic body, and the rim of the open side of the auxiliary body is joined with the wall or the opening rim of the opening.

7. The method as claimed in claim 6, wherein the auxiliary body is provided having a predetermined internal volume of the auxiliary body, which internal volume is dimensioned such that, after the joining of the auxiliary body, the pressure vessel having the desired final internal volume is obtained.

8. The method as claimed in claim 1, wherein the joining of the auxiliary body comprises at least one of welding, gluing, pressing, soldering.

9. The method as claimed in claim 1, wherein the auxiliary body is provided as a deep-drawn part.

10. The method as claimed in claim 1, wherein the basic body is provided having a plurality of openings distributed in the wall, and wherein a plurality of auxiliary bodies are provided, which, in order to obtain the pressure vessel having the desired final internal volume, are joined with the basic body at the openings.

11. A pressure vessel for a motor vehicle, comprising
a hollow basic body, wherein the basic body has an internal volume, and wherein the basic body has a wall, which extends fully around a longitudinal axis of the basic body, wherein the wall has an opening, which has an opening rim, and
a hollow auxiliary body, which has a base wall and a peripheral wall, wherein the peripheral wall is open on a side lying opposite the base wall,
wherein the auxiliary body is joined with the basic body at the opening in the wall of the basic body, whereby the pressure vessel has an internal volume which is larger or smaller than the internal volume of the basic body.

12. The pressure vessel as claimed in claim 11, wherein a contour and dimensioning of the peripheral wall of the auxiliary body is at least approximately matched to a contour and dimensioning of the opening rim of the opening in the wall of the basic body.

13. The pressure vessel as claimed in claim 11, wherein the auxiliary body is inserted partially into the opening in the wall of the basic body with the open side to the fore.

14. The pressure vessel as claimed in claim 11, wherein the auxiliary body inserted at least partially into the opening with the base wall to the fore.

15. The pressure vessel as claimed in claim 11, wherein the auxiliary body has on its open side a rim and the auxiliary body is fixed to the basic body with the rim around the opening in the wall of said basic body, and the rim of the open side of the auxiliary body is joined with the wall of the basic body.

16. The pressure vessel as claimed in claim 11, wherein the auxiliary body has on its open side a rim, and the auxiliary body is fixed to the basic body with the rim around the opening in the wall of said basic body, and the rim of the open side of the auxiliary body is joined with the opening rim of the opening.

17. The pressure vessel as claimed in claim 11, wherein the pressure vessel is an air suspension pot of an air suspension.

18. The method as claimed in claim 4, wherein the joining of the auxiliary body comprises a joining of the peripheral wall of the auxiliary body with the opening rim of the opening in the wall.
